(19) United States
(12) Patent Application Publication
(10) Pub. No.: US 2024/0178526 A1
(43) Pub. Date: May 30, 2024

(54) BATTERY SYSTEM AND METHOD OF ASSEMBLING THEREOF

(71) Applicant: SAMSUNG SDI CO., LTD., Yongin-si (KR)

(72) Inventor: Markus Ridisser, Premstätten (AT)

(21) Appl. No.: 18/485,259

(22) Filed: Oct. 11, 2023

(30) Foreign Application Priority Data
Nov. 30, 2022 (EP) 22210403.6

(51) Int. Cl. H01M 50/507; H01M 10/42; H01M 10/48

(52) U.S. Cl. CPC H01M 50/507; H01M 10/425; H01M 10/482; H01M 2010/4271; H01M 2220/20

(57) ABSTRACT

A battery system includes: a battery pack including a plurality of battery cells having electrode terminals; and a cell contacting unit (CCU) on the battery pack. The CCU includes an electrically isolating carrier covering at least the terminals of the battery cells, a plurality of busbars electrically connecting the terminals of the battery cells, and sensors configured to detect a physical property of the battery cells. The busbars and the sensors are on a first side of the carrier facing the battery cells, and the carrier has a plurality of access openings for providing access to the busbars from a second side of the carrier opposite to the first side. The access openings in the carrier are closed by an adhesive

### CROSS-REFERENCE TO RELATED APPLICATION

This application claims priority to and the benefit of European Patent Application No. 22210403.6, filed on Nov. 30, 2022, in the European Intellectual Property Office, the entire content of which is hereby incorporated by reference.

### BACKGROUND

### 1. Field

Aspects of embodiments of the present disclosure relate to a battery system and to a method of assembling a battery system.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or be a hybrid vehicle powered at least in part by, for example, a gasoline generator. Furthermore, the vehicle may include a combination of electric motor and conventional combustion engine.

Generally, an electric-vehicle battery (EVB), or traction battery, is a battery used to power the propulsion of battery electric vehicles (BEVs). Electric-vehicle batteries differ from starting, lighting, and ignition batteries in that they are designed to provide power over sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as a power supply for small electronic devices, such as cellular phones, notebook computers, and camcorders, while high-capacity rechargeable batteries are used as the power supply for hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, for example cylindrical or rectangular, depends on the battery's intended purpose. Lithium-ion (and similar lithium polymer) batteries, widely known via their use in laptops and consumer electronics, dominate recent electric vehicles in development.

Rechargeable batteries may be used as a battery module formed of a plurality of unit battery cells coupled to each other in series and/or in parallel to provide a high energy density, in particular for motor driving of a hybrid vehicle. For example, the battery module is formed by interconnecting the electrode terminals of the plurality of unit battery cells in an arrangement that depends on a desired amount of power and to realize a high-power rechargeable battery.

Battery modules can be constructed in either block design or modular design. In block designs, each battery is coupled to a common current collector structure and a common battery management system, and the unit thereof is arranged in a housing. In modular designs, pluralities of battery cells are connected to each other to form submodules, and several submodules are connected to each other to form the battery module. In automotive applications, battery systems often consist of a plurality of battery modules connected to each other in series to provide a desired voltage. Therein, the battery modules may include submodules with a plurality of stacked battery cells, and each stack may include cells connected to each other in parallel that are connected to each other in series (XpYs) or multiple cells connected to each other in series that are connected to each other in parallel (XsYp).

A battery pack includes any number of battery modules. Generally, the battery modules are identical. The battery modules may be configured (e.g., may be connected to each other) in a series, parallel, or a mixture of both to deliver the desired voltage, capacity, and/or power density. Components of the battery packs include the individual battery modules and the interconnects, which provide electrical conductivity between them.

Such battery packs are integrated by using appropriate mechanical and electrical connections between the individual components (e.g., between the battery modules). These connections should remain functional and safe throughout the average service life of the battery system. Further, installation space and interchangeability specifications must be met, which are especially important in mobile applications.

Conventional battery systems usually include a plastic carrier equipped with electrical components and arranged on a battery pack. Cell voltages and temperatures measurements are led to a central or decentral battery management module (BMM) via one or more cables. Another component, such as a touch protection covering all electrical components is also installed to protect a user or technician. Consequently, many individual components must be assembled through several steps on an assembly line, resulting in a burdensome assembly process.

### SUMMARY

The present disclosure is defined by the appended claims and their equivalents. Any disclosure lying outside the scope of the claims and their equivalents is intended for illustrative and/or comparative purposes.

According to embodiment of the present disclosure, a battery system includes a battery pack including: a plurality of battery cells having electrode terminals; and cell contacting unit (CCU) on the battery pack. The CCU includes an electrically isolating carrier covering at least the terminals of the battery cells, a plurality of busbars electrically connecting the terminals of the battery cells, and sensors configured to detect a physical property of the battery cells. The busbars and the sensors are on a first side of the carrier facing the battery cells. The carrier has a plurality of access openings for providing access to the busbars from a second side of the carrier opposite to the first side, and the access openings in the carrier are closed by an adhesive.

According to an embodiment of the present disclosure, the CCU may further include a plug extending through the carrier from the first side to a second side opposite to the first side of the carrier, and a battery management module (BMM) on the second side of the carrier is electrically connected to the sensors via the plug.

According to an embodiment of the present disclosure, the carrier may have a first section having a corrugated shape with elevations and a depression, and the elevations may accommodate (or form) degassing channels between the carrier and the battery cells.

According to another embodiment of the present disclosure, a method for assembling a battery system is provided. In the method, a battery pack including a plurality of battery cells having electrode terminals is provided. Further, a cell contacting unit (CCU) is arranged on the battery pack. The CCU includes an electrically isolating carrier covering at least the terminals of the battery cells, a plurality of busbars for electrically connecting the terminals of the battery cells, and sensors configured to detect a physical property of the battery cells. The plurality of busbars and the sensors are on a first side of the carrier facing the battery cells. The carrier has a plurality of access openings for providing access to the busbars from a second side of the carrier opposite to the first side. In a further step, the terminals of the battery cells and the plurality of busbars are electrically connected via the access openings, and an adhesive is applied onto or into the access openings in the carrier.

According to another embodiment of the present disclosure, a battery pack including a plurality of battery cells having electrode terminals is provided. Further, a cell contacting unit (CCU) is arranged on the battery pack. The CCU includes an electrically isolating carrier covering at least the terminals of the battery cells, a plurality of busbars for electrically connecting the terminals of the battery cells, and sensors configured to detect a physical property of the battery cells. The plurality of busbars and the sensors are on a first side of the carrier facing the battery cells. The CCU further includes a plug extending through carrier from the first side to a second side opposite to the first side of the carrier. In a further step, a battery management module (BMM) is arranged on the second side and is electrically connected to the sensors via the plug.

According to another embodiment of the present disclosure, a method for assembling a battery system is provided. In one step, a battery pack including a plurality of battery cells having electrode terminals is provided. Further, a cell contacting unit (CCU) is arranged on the battery pack. The CCU includes an electrically isolating carrier covering at least the terminals of the battery cells, a plurality of busbars for electrically connecting the terminals of the battery cells, and sensors configured to detect a physical property of the battery cells. The plurality of busbars and the sensors are on a first side of the carrier facing the battery cells. The carrier has a first section having a corrugated shape with elevations and a depression, and, by arranging the CCU on the battery pack, the elevations accommodate (or form) degassing channels between the carrier and the battery cells.

Features described with respect to one embodiment of the present disclosure may be interchangeably used for other aspects and features of other embodiments of the present disclosure.

Further aspects and features of the present disclosure can be learned from the dependent claims or the following description.

### BRIEF DESCRIPTION OF THE DRAWINGS

Aspects and features of the present disclosure will become apparent to those of ordinary skill in the art by describing, in detail, embodiments thereof with reference to the attached drawings in which:

FIG. 1 is a schematic view of a rear side of a cell contacting unit (CCU) in an unassembled state according to an embodiment;

FIG. 2 is a schematic view of the rear side of the CCU shown in FIG. 1 in an assembled state;

FIG. 3 is a perspective view of a battery system showing a front side of the CCU shown in FIG. 2 according to an embodiment; and

FIG. 4 is a flow chart describing a method for assembling a battery system according to an embodiment.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure may, however, be embodied in various different forms and should not be limited to the embodiments illustrated herein. Rather, these embodiments are provided as examples so that this disclosure will be thorough and complete, and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be simplified.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one embodiment of the present disclosure, a battery system includes a battery pack including a plurality of battery cells having electrode terminals and cell contacting unit (CCU) disposed on the battery pack (e.g., disposed or arranged on the battery cells). The CCU includes an electrically isolating carrier covering at least the terminals of the battery cells, a plurality of busbars electrically connecting the terminals of the battery cells, and sensors for detecting at least one physical property of the battery cells. The busbars and the sensors are arranged on, and, in some embodiments, fixed to, a first side of the carrier facing the battery cells. Further, the carrier has a plurality of access openings providing access to (e.g., exposing) the busbars from a second side of the carrier opposite to the first side. The access openings of the carrier may be closed (e.g., sealed) by an adhesive.

For example, the CCU disposed on the battery pack provides multiple functions and uses within a single component.

Firstly, in a battery pack according to an embodiment of the present disclosure, the mounting of the busbars and the sensors on the first side of the carrier (e.g., by welding or soldering) and providing (or forming) the access openings through the carrier (e.g., by drilling, laser and/or chemical etching, or the like) can be carried out in advance (e.g., before the CCU is attached to the battery cells). Therefore, the CCU can be substantially preassembled. Preassembled CCUs facilitate transportation and the packaging thereof. Furthermore, the assembly process can be streamlined by mounting the CCU on the battery pack as a multifunctional component instead of individually mounting several different components, each of which would fulfill a different function. Moreover, the access openings in the carrier allow access to the busbars from the second side of the carrier. Thus, the busbars may be easily connected to the terminals of the battery pack (e.g., by welding) via access provided by the access openings. Therefore, the mounting of the CCU on the battery pack may be further facilitated. The production assembly steps and the number of welding spots can be reduced and additional sources of potential error can be avoided. It is, however, to be understood that the mounting is not limited to only the described components, and other components may be mounted on the CCU in advance to analogously provide the above-described preassembly.

Secondly, because the electrically isolated carrier covers at least the terminals of the battery cells, the CCU provides touch protection for the electronic components, such as the terminals and the busbars, and electrically isolates the electronic components from the second side of the carrier. After the busbars have been electrically connected to the terminals, the access openings may be closed (or covered or sealed) by an adhesive. The adhesive also provides electrical isolation to establish complete and continuous touch protection along the second side of the carrier. The adhesive may be implemented as glue tabs, such as glue tabs applied on the carrier covering the access openings. Alternatively or additionally, a liquid adhesive, a liquified adhesive, and/or a flowable adhesive may be filled into the access openings, which then solidifies or is solidified in the openings. For example, the carrier and the adhesive closing the access openings act as electrical isolation shielding for the electronic components of the battery pack and the CCU.

The plurality of busbars may be divided into different groups (e.g., according to a specified arrangement thereof, such as in rows, for example) in which at least one first group of busbars is configured to electrically connect positive electrodes of the battery cells and at least one second group of busbars is configured to electrically connect negative electrodes of the battery cells. The carrier may have one access opening for each group of busbars, one access opening for each busbar, or a combination thereof. The electrical connections or interconnections described herein may be provides by wires or conducting elements, such as conductive lines on a printed circuit board (PCB) or another kind of circuit carrier. The conducting elements may include metallizations, such as surface metallization and/or pins, and/or may include conductive polymers or ceramics. Each of the groups of busbars may be electrically connected via flat flexible cables (FFC) to one or more circuit boards, such as a collector board. The FFCs and the circuit board(s) may also be arranged on, and may be fixed to, the first side of the carrier by, for example, welding or soldering. The FFCs and the circuit board(s) may be arranged on or fixed to the first side of the carrier in advance of the assembling of the battery system.

The sensor may be configured to detect at least one physical property of the battery cells, such as a temperature, a voltage, a current, an electrical power, or the like. How such sensors may be implemented to detect the at least one physical property is known to those skilled in the relevant art and, thus, a corresponding detailed discussion thereof is omitted.

The battery system may further include a battery management system (BMS), which is an electronic system that manages the rechargeable battery, battery module, and battery pack, such as by protecting the batteries from operating outside their safe operating area, monitoring their states, calculating secondary data, reporting that data, controlling its environment, authenticating it, and/or balancing it. Operation thereof outside the safe operating area may be indicated by an over-current, an over-voltage (e.g., during charging), over-temperature, under-temperature, over-pressure, and ground fault or leakage current detection.

According to an embodiment, the battery system may further include a battery management module (BMM) arranged on, and in some embodiments, fixed to, the second side of the carrier. In some embodiments, the battery system may include a plurality of BMMs. The BMMs may be part of the system's battery modules and may be configured to obtain and to process relevant information on a module level. That is, the BMM may be configured to detect, for example, individual cell voltages and temperatures of the battery cells in a battery module. Because the second side of the carrier faces away from the battery pack, the arrangement of the BMM(s) on the second side of the carrier facilitates assembly, repair, and maintenance of the battery system and, in particular, of the BMMs.

According to an embodiment, the carrier may have a first section having a corrugated shape with elevations and at least one depression between the elevations. In some embodiments, the first section of the carrier may have a plurality of depressions respectively between adjacent elevations. The elevations accommodate (or form) degassing channels between the carrier and the battery cells. The at least one depression, and in some embodiments, each of the depressions, may be located to adjoin at least one elevation and may be located between two elevations. The carrier may have a second section or a plurality of sections having a similar corrugated shape as the first section to increase the number of degassing channels. Degassing channels facilitate the discharge of gas to the outside such that the internal pressure of the battery system may not increase to a point at which the stability of the battery system deteriorates. In other words, the shape of the section(s) of the carrier having the corrugated shape is configured to constitute, together with a surface of the battery cells, the shape of degassing channels without requiring separate components for constructing (or providing) degassing channels. Thus, assembling of the battery system may be further facilitated.

The battery system may further include at least one BMM, for example, the above-described BMM, accommodated in the at least one depression. This provides a compact arrangement of the at least one BMM in the battery system without requiring additional space or effort when assembling or repairing the battery system. Furthermore, when the at least one depression adjoins at least one elevation, the BMM is located directly next to at least one degassing channel, which is accommodated in the at least one elevation.

The CCU may further include at least one plug extending through carrier from the first side to the second side and electrically connected to the sensor. The at least one BMM is electrically connected to the sensor via the at least one plug. For example, the BMM, arranged on the second side of the carrier and/or in the depression, may be directly plugged to (or connected to) the plug to establish an electrical connection between the BMM and the sensor arranged on the first side of the carrier.

According to another embodiment, a shape of the carrier may correspond to at least a base of the plurality of battery cells. For example, the carrier may be shaped to cover an entire surface of the battery cells and/or the battery pack facing the first side of the carrier. By entirely covering the battery cells and/or the battery pack in one direction, complete touch protection may be provided.

According to an embodiment, the arrangement of the access openings corresponds to the arrangement of the terminals of the battery cells when the CCU is disposed on the battery pack. For example, an access opening may be provided for a terminal of each of the battery cells. This reduces the amount of adhesive necessary for electrical shielding while providing sufficient space to access the busbars.

According to another embodiment of the present disclosure, an electric vehicle includes the battery system as described herein. The aspects and features of the battery system as described above can be analogously provided to the electric vehicle. Therefore, a repeat description thereof is omitted.

According to another embodiment of the present disclosure, there a method for assembling a battery system is provided. The battery system may be the battery system as described herein. According to an embodiment of the method, a battery pack including a plurality of battery cells with electrode terminals is provided. Further, a cell contacting unit (CCU) is disposed on the battery pack. The CCU includes an electrically isolating carrier covering at least the terminals of the battery cells, a plurality of busbars for electrically connecting the terminals of the battery cells, and sensors for detecting at least one physical property of the battery cells. The plurality of busbars and the sensors are arranged on, and in some embodiments, fixed to, a first side of the carrier facing the battery cells. The carrier has a plurality of access openings for providing access to the busbars from a second side of the carrier opposite to the first side. In a subsequent step, the terminals of the battery cells and the plurality of busbars are electrically connected via the access openings, and an adhesive is applied onto or into the access openings in the carrier.

The aspects and features of the battery system described about and its optional features can be analogously achieved by the method for assembling a battery system and its optional features. Therefore, a recurring description thereof is omitted.

According to an embodiment of the present disclosure, at least one battery management module (BMM) may be arranged on, and in some embodiments, fixed to, the second side of the carrier, and a method of manufacturing the battery system may further include a step of electrically connecting the BMM with the sensor(s).

According to an embodiment of the present disclosure, the carrier may have a first section having a corrugated shape with elevations and at least one depression, and, by disposing the CCU on the battery pack, the elevations may accommodate (or form) degassing channels arranged between the carrier and the battery cells.

At least one BMM, for example, the above-described BMM, may be accommodated in the at least one depression. The method of manufacturing a battery system may include a step of arranging at least one BMM, for example, the above-mentioned BMM, in the at least one depression.

The CCU may further include at least one plug extending from the first side to the second side of the carrier and electrically connected to the sensor, and the at least one BMM may be electrically connected to the sensor via the at least one plug. The method of manufacturing a battery system may further include a step of electrically connecting the at least one BMM to the sensor via the at least one plug.

According to an embodiment, a shape of the carrier may correspond to at least a base of the plurality of battery cells. For example, the carrier may be shaped to cover an entire surface of the battery cells and/or the battery pack facing the first side of the carrier. By entirely covering the battery cells and/or the battery pack in one direction, complete touch protection may be provided.

According to an embodiment, the arrangement of the access openings may correspond to the arrangement of the terminals of the battery cells when the CCU is disposed on the battery pack.

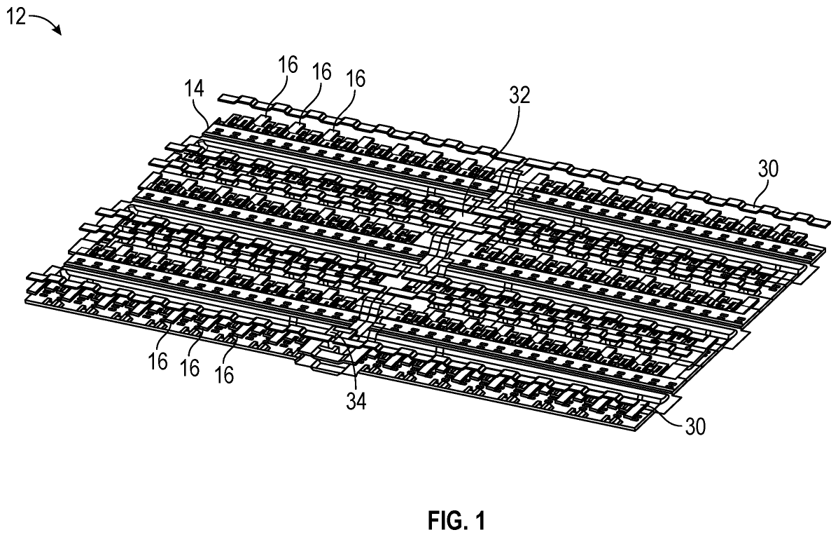

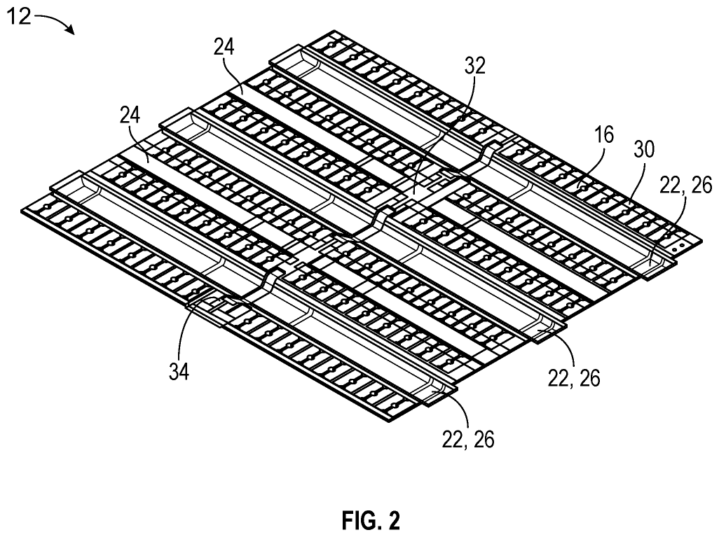

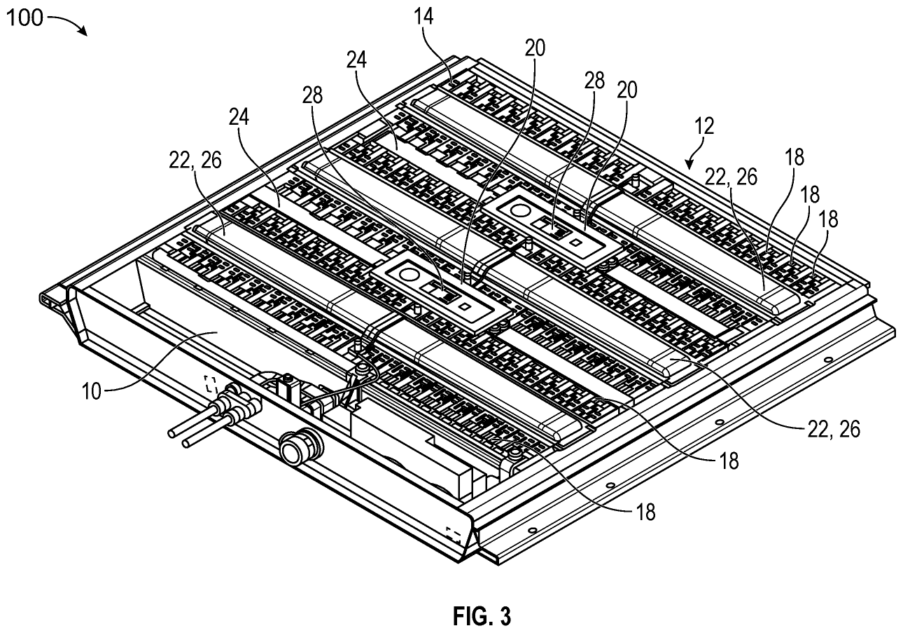

FIGS. 1 and 2 are schematic views of a rear side of a cell contacting unit (CCU) 12 in an unassembled state (FIG. 1) and in an assembled state (FIG. 2) according to an embodiment. The CCU 12 may be disposed on a battery pack 10 including a plurality of battery cells having electrode terminals to constitute a battery system, for example, the battery system 100 illustrated in FIG. 3. The CCU 12 disposed on the battery pack 10 provides multiple uses combined by or implemented via a single component.

FIG. 1 depicts the rear side (e.g., a first side) of the CCU 12 including an electrically isolating carrier 14 and several components, including a plurality of busbars 16, a plurality of flat flexible cables (FFC) 30, a plurality of long collector boards 32, and a plurality of short collector boards 34, which are to be mounted on the rear side (e.g., the first side) of the carrier 14. The rear side is a side of the CCU 12 facing the battery pack 10 when the CCU 12 is disposed on the battery pack 10. To improve the intelligibility of the drawings, the components to be mounted on the rear side of the carrier 14 are shown in an exploded configuration in which they are lifted above their designated places on the carrier 14 while the CCU 12 is shown in an assembled state in FIG. 2. According to embodiments of the present disclosure, the mounting of the components on the rear side of the carrier 14 can be carried out in advance (e.g., before assembly with the battery cells). Therefore, the CCU 12 can be preassembled. Preassembled CCUs facilitate transportation and the packaging thereof. Furthermore, the assembly process of a battery system, for example, of the battery system 100 shown in FIG. 3, can be streamlined by mounting the CCU 12 on the battery pack 10 as a multifunctional component instead of mounting several individual components, each fulfilling a different function.

The carrier 14 is shaped to cover the battery cells of the battery pack 10 on the side at where the terminals are located. For example, the carrier 14 entirely covers the top side of the battery pack 10 as shown in FIG. 3. Due to the shape of the carrier 14, the CCU 12 provides touch protection for the components arranged on the rear side of the carrier 14 when the CCU 12 is disposed on the battery pack 10. As a result, the components mounted on the rear side of the carrier 14 and the terminals of the battery cells are electrically isolated from a front side (e.g., a second side opposite to the first side) of the carrier 14.

The shape of the carrier 14 may be rectangular. The carrier 14, however, is not limited to the rectangular shape. In other embodiments, the carrier 14 may be any suitable shape, for example, square-shaped, ellipsoidal-shaped, or circular-shaped. For example, the carrier 14 may have a shape that is adapted to or corresponds to the shape of the battery pack 10, such as to the shape of a base structure of the battery pack 10.

The busbars 16 are arranged on the rear side of the carrier 14 to provide an electrical connection between the terminals of the battery cells when the CCU 12 is disposed on the battery pack 10. The busbars 16 are arranged in rows. For example, the carrier 14 shown in FIGS. 1 and 2 has six rows of busbars 16, with three rows of busbars 16 being arranged to electrically connect positive electrodes of the terminals (e.g., positive terminals) of the battery cells and three rows of busbars being arranged to electrically connect negative electrodes of the terminals (e.g., negative terminals) of the battery cells. This arrangement is merely an example, however, and the arrangement of the busbars 16 on the carrier 14 is generally dependent on the arrangement and shape of the battery cells and their terminals in the battery pack 10.

Each row of busbars 16 is contacted via the FFC 30 mounted on the busbars 16 along the row direction. The FFCs 30 have a corrugated shape to properly fit into gaps between the busbars 16 in a space-saving manner. The FFCs 30 are electrically connected to the long collector boards 32 and/or the short collector boards 34 mounted on the rear side of the carrier 14. The collector boards 32, 34 are arranged orthogonally to the FFCs 30, thereby providing electrical connection between the rows of busbars 16, in particular, between adjacent rows of busbars 16. The components, such as the busbars 16, the FFCs 30, and the collector boards 32, 34, may be fixedly mounted on the rear side of the carrier 14 by welding or soldering (see, e.g., FIG. 2) to provide a preassembled CCU 12 for easy assembly with the battery pack in a production assembly line.

The CCU 12 further includes sensors configured to detect at least one physical property of the battery cells. The physical property to be detected may be, for example, a temperature of the battery cells. The physical property to be detected may, however, be a voltage, a current, an electrical power, or any combination thereof. How to implement such sensors to detect the at least one physical property is known to those skilled in the relevant art, and therefore, a corresponding detailed discussion thereof is omitted.

As best seen in FIGS. 2 and 3, the carrier 14 has a corrugated shape with, in the illustrated embodiment, three elevations 22 and four depressions 24 extending parallel to the rows of busbars 16. The elevations 22 and the depressions 24 are arranged in an alternating manner. When the CCU 12 is disposed on the battery pack 10 (see, e.g., FIG. 3), each of the elevations 22 accommodates (or forms) a degassing channel 26 arranged between the carrier 14 and the battery cells of the battery pack 10. The degassing channels 26 facilitate the discharge of gas to the outside such that the internal pressure of the battery system 100 may not increase to a point at which the stability of the battery system 100 deteriorates. According to the embodiment of the battery system 100 shown in FIG. 3, no separate component is used (or included) to form the degassing channels 26, such as steel pipe, for example. Thus, assembling of the battery system 100 may be easily facilitated. It is to be understood that the number of elevations 22 and depressions 24 shown in FIGS. 2 and 3 is merely an example, and the present disclosure is not limited to that number. The carrier 14 may also have only a section or a plurality of sections having corrugated shapes with arbitrary numbers of elevations 22 and depressions 24.

FIG. 3 is a perspective view of a battery system 100 according to an embodiment. The battery system 100 includes the battery pack 10 and the CCU 12. The battery pack 10 is accommodated in a framework, which is open at the top side to allow access to the top side of the battery pack 10, for example, to the side of the battery pack 10 exposing the terminals. That is, the CCU 12 can be mounted on the battery pack 10 via the top side of the battery pack 10. A base structure of the framework corresponds to the base structure of the battery pack 10 such that a compact and space-saving battery system 100 may be provided.

As best seen in FIG. 3, the carrier 14 has a plurality of access openings 18 to provide access to the busbars 16 from the front side of the carrier 14. Each of the busbars 16 is exposed to the front side of the carrier 14 via an access opening 18. The access openings 18 are provided to the carrier 14 in advance by, for example, drilling, laser etching, and/or chemical etching. The access openings 18 are provided in the carrier 14 for use during the assembling of the battery system 100 and to facilitate the assembly procedure of the battery system 100. The access openings 18 allow for access to the busbars 16 from the front side of the carrier 14 such that the busbars 16 may be easily welded to the terminals of the battery cells of the battery pack 10 through the access openings 18 to electrically connect the terminals and the busbars 16 to each other.

After the busbars 16 have been welded to the terminals, the access openings 18 are closed by an electrically isolating adhesive. For example, the access openings 18 in the carrier 14 are closed (e.g., filled and/or sealed) by an electrically isolating adhesive. The adhesive provides electrical isolation to provide continuous touch protection along the front side of the carrier 14. The adhesive may be implemented as glue tabs, each applied onto the carrier 14 and covering the access openings 18. Alternatively or additionally, a liquid adhesive, a liquified adhesive, and/or a flowable adhesive may be filled into the access openings 18, which then solidifies in the access opening 18.

As further illustrated in FIG. 3, the battery system 100 further includes two battery management modules (BMM) 20, each accommodated in one of the depressions 24 of the carrier 14. This allows for a compact arrangement of the BMMs 20 in the battery system 100 without requiring additional space or effort when assembling or repairing the battery system 100. Furthermore, each of the BMMs 20 is directly located in between of two of the degassing channels 26.

The CCU 12 further includes two plugs 28 extending through the carrier 14 from the rear side to the front side of the carrier 14. Each of the plugs 28 is electrically connected to the sensors and to one of the BMMs 20 to establish an electrical connection between the BMMs 20 and the sensors, which arranged on different sides (e.g., the rear and front sides) of the carrier 14. The BMMs 20 are configured to communicate with the sensors via the electrical connection provided by the plugs 28. The communication includes transmission of detected parameters of the physical property by the sensors from the sensors to the BMMs 20 such that the BMMs 20 can process relevant information on a module level.

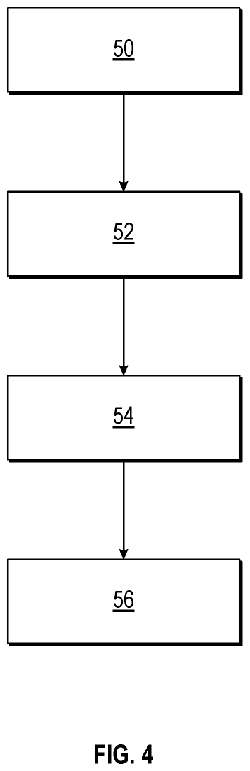

FIG. 4 is a flow chart describing a method for assembling a battery system according to an embodiment.

During a first step 50, a battery pack 10 including a plurality of battery cells with electrode terminals is provided. For example, the above-described battery pack 10 may be provided.

A second step 52 of the method includes disposing a cell contacting unit (CCU) 12 on the battery pack 10. The CCU 12 includes an electrically isolating carrier 14 covering at least the terminals of the battery cells, a plurality of busbars 16 for electrically connecting the terminals of the battery cells, and sensors for detecting at least one physical property of the battery cells. The plurality of busbars 16 and the sensors are arranged on a rear side of the carrier 14 facing the battery cells. The carrier 14 has a plurality of access openings 18 for providing access to the busbars 16 from a front side of the carrier 14. For example, the above-described CCU 12 may be used.

In a third step 54, the terminals of the battery cells and the plurality of busbars 16 are electrically connected via access provided by the access openings 18. For example, the busbars 16 are welded to the terminals.

During a fourth step 56, an adhesive is applied onto or into the access openings 18 in the carrier 14.

### REFERENCE SIGNS

10 battery pack
12 cell contacting unit
14 electrically isolating carrier
16 busbars
18 access openings
20 battery management module
22 elevations
24 depressions
26 degassing channels
28 plug
30 flat flexible cable
32 collector board, long
34 collector board, short
50 first method step
52 second method step
54 third method step
56 fourth method step
100 battery system

What is claimed is:

1. A battery system comprising:
a battery pack comprising a plurality of battery cells having electrode terminals; and
a cell contacting unit (CCU) on the battery pack, the CCU comprising an electrically isolating carrier covering at least the terminals of the battery cells, a plurality of busbars electrically connecting the terminals of the battery cells, and sensors configured to detect a physical property of the battery cells,
wherein the busbars and the sensors are on a first side of the carrier facing the battery cells,
wherein the carrier has a plurality of access openings for providing access to the busbars from a second side of the carrier opposite to the first side, and
wherein the access openings in the carrier are closed by an adhesive.

2. The battery system according to claim 1, further comprising a battery management module (BMM) on the second side of the carrier.

3. The battery system according to claim 2, wherein the carrier has a first section having a corrugated shape having elevations and a depression, and
wherein the elevations accommodate degassing channels arranged between the carrier and the battery cells.

4. The battery system according to claim 3, wherein the BMM is accommodated in the depression.

5. The battery system according to claim 3, wherein the CCU further comprises a plug extending through the carrier from the first side to the second side,
wherein the BMM is electrically connected to the sensors via the plug.

6. The battery system according to claim 1, wherein a shape of the carrier corresponds to a base of the plurality of battery cells.

7. The battery system according to claim 1, wherein an arrangement of the access openings corresponds to an arrangement of the terminals of the battery cells when the CCU is on the battery pack.

8. An electric vehicle comprising the battery system according to claim 1.

9. A method for assembling a battery system, the method comprising:
providing a battery pack comprising a plurality of battery cells having electrode terminals; and
disposing, on the battery pack, a cell contacting unit (CCU), the CCU comprising an electrically isolating carrier covering at least the terminals of the battery cells, a plurality of busbars for electrically connecting the terminals of the battery cells, and sensors configured to detect a physical property of the battery cells, the plurality of busbars and the sensors being on a first side of the carrier facing the battery cells, the carrier having a plurality of access openings for providing access to the busbars from a second side of the carrier opposite to the first side;
electrically connecting the terminals of the battery cells and the plurality of busbars via the access openings; and
applying an adhesive onto or into the access openings in the carrier.

10. The method according to claim 9, further comprising electrically connecting battery management module (BMM) with the sensors,
wherein the BMM is on the second side of the carrier.

11. The method according to claim 10, wherein the carrier has a first section having a corrugated shape with elevations and a depression,
wherein, by arranging the CCU on the battery pack, the elevations accommodate degassing channels arranged between the carrier and the battery cells.

12. The method according to claim 11, further comprising arranging the BMM in the depression.

13. The method according to claim 10, further comprising electrically connecting the BMM to the sensors via a plug extending from the first side to the second side of the carrier.

14. The method according to claim 9, wherein a shape of the carrier corresponds to a base of the plurality of battery cells.

15. The method according to claim 9, wherein an arrangement of the access openings corresponds to an arrangement of the terminals of the battery cells when the CCU is on the battery pack.
